(19) United States
(12) Patent Application Publication
(10) Pub. No.: US 2016/0092841 A1
(43) Pub. Date: Mar. 31, 2016

(54) MOBILE JOB POSTING

(71) Applicant: Linkedln Corporation, Mountain View, CA (US)

(72) Inventor: Sachit Kamat, San Carlos, CA (US)

(21) Appl. No.: 14/586,659

(22) Filed: Dec. 30, 2014

Related U.S. Application Data
(60) Provisional application No. 62/057,835, filed on Sep. 30, 2014.

(51) Int. Cl. G06Q 10/10; G06Q 50/00; G06Q 20/14

(52) U.S. Cl. CPC G06Q 10/1053; G06Q 20/145; G06Q 50/01

(57) ABSTRACT

A mobile computing device displays details of a job that is posted on a social networking service as an unpaid job posting together with an option for upgrading the unpaid job posting to a paid job posting with associated advantages in comparison to the unpaid job posting. The mobile computing device displays a fee for the upgrade and at least one of the associated advantages of the paid job posting. The mobile computing device displays a user interface option for requesting that other associated advantages of the paid job posting be presented. The mobile computing device displays a specified number of other associated advantages of the paid job posting if a user selects this option. If a user elects to upgrade an unpaid job posting to a paid job posting, the mobile computing device will present the user with an interface for payment of the fee for the upgrade.

### CROSS REFERENCE TO RELATED APPLICATIONS

This application claims the benefit of U.S. Provisional Application No. 62/057,835, filed Sep. 30, 2014, the entire disclosure of which is incorporated herein by reference thereto.

### TECHNICAL FIELD

The present disclosure generally relates to providing job posting services via mobile computing devices. Furthermore, computer program products, methods, and systems are described for using social network information to provide users of mobile computing devices with job posting services with bifurcated functions and features for paid and unpaid job postings, such that paid job postings are subject to the benefits of a first set of functions and features, while unpaid job postings are subject to the benefits of a second set of functions and features.

### BACKGROUND

A typical job posting procedure involves a representative of a company researching job hosting services and selecting at least one for posting (e.g., listing) a job so that users of the job hosting service may search for, browse, and in some cases, apply for the job associated with the particular job posting. In exchange for making the job posting available for presentation to the users of the job hosting service, the company on whose behalf the job is posted will typically pay a fee. With some job hosting services, different price points may provide different benefits in terms of how the job posting is handled. For example, the amount of the fee may be tied to the length of time that the job posting is active on the job hosting service.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating a system for providing job posting services to a user of a mobile computing device, consistent with some embodiments.

FIG. 2 is a block diagram illustrating various components of a social network server with a job posting module and a job extraction module.

FIG. 3 is a display diagram illustrating job posting user interface options provided to a user of a mobile computing device.

FIG. 4 is a display diagram illustrating job posting user interface options provided to a user of a mobile computing device.

FIG. 5 is a display diagram illustrating job posting user interface options provided to a user of a mobile computing device.

FIG. 6 is a flow diagram illustrating an example method performed by a server associated with a social networking service to provide information and functionality associated with job postings via a mobile computing device.

FIG. 7 is a flow diagram illustrating an example method for displaying information associated with job postings via a mobile computing device, consistent with some embodiments.

FIG. 8 is a block diagram of a machine in the form of a computing device within which a set of instructions, for causing the machine to perform any one or more of the methodologies discussed herein, may be executed.

FIG. 9 is a block diagram illustrating a mobile device for use according to any one or more of the methodologies discussed herein.

### DETAILED DESCRIPTION

### Overview

The present disclosure describes methods, systems, and computer program products, which individually provide functionality for job posting services to a user of a mobile computing device. In some examples, the systems and methods display details of a job posting hosted on a social networking service proximate to at least one user interface object associated with the job posting on the social networking service. The user interface objects may provide information and functionality associated with the job posting on the social networking service. For example, when a mobile computing device user selects a user interface object, the systems and methods identify and/or obtain information associated with the job posting that is located or otherwise stored at the social networking service. Once the information is identified and/or obtained, the systems and methods provide the information to the user of the mobile computing device. The information may, for example, be related to benefits or advantages associated with upgrading an unpaid job posting to a paid job posting on the social networking service.

For example, a mobile computing device may display representative details (e.g., company, position, salary, etc.) of a job listing on a social networking service, along with a user-selectable button that, upon being selected by a user of the mobile computing device, causes the mobile computing device to access further details associated with the job listing (e.g., experience required, education required, location information, and so on) on a server of the social networking service. The mobile computing device may then present the accessed information to the job candidate for review.

In some examples, a mobile computing device presenting job listings may selectively present job listings and/or user interface objects that facilitate the upgrading of an unpaid job listing on the social networking service to a paid job listing with associated advantages (e.g., more placements of the job across the social networking service) in comparison to an unpaid job posting. For example, selection of a user interface object may cause the mobile computing device to receive information identifying advantages associated with a paid job posting on the social networking service and present these advantages to a user of the mobile computing device.

In another example, a user of the mobile computing device may select a user interface object associated with a request to upgrade an unpaid job posting on the social networking service to a paid job posting on the social networking service. The mobile computing device may then display user interface objects that facilitate the payment of a fee for upgrading an unpaid job listing on the social networking service to a paid job listing. For example, a user interface object may provide fields for the user to enter credit card information associated with a credit card used to pay the fee for the upgrade.

In the following description, for purposes of explanation, numerous specific details are set forth in order to provide a thorough understanding of the various aspects of different embodiments of the present subject matter. It will be evident, however, to one skilled in the art, that the present subject matter may be practiced without all of the specific details.

Other aspects of the inventive subject matter will be readily apparent from the description of the figures that follows.

### Suitable System

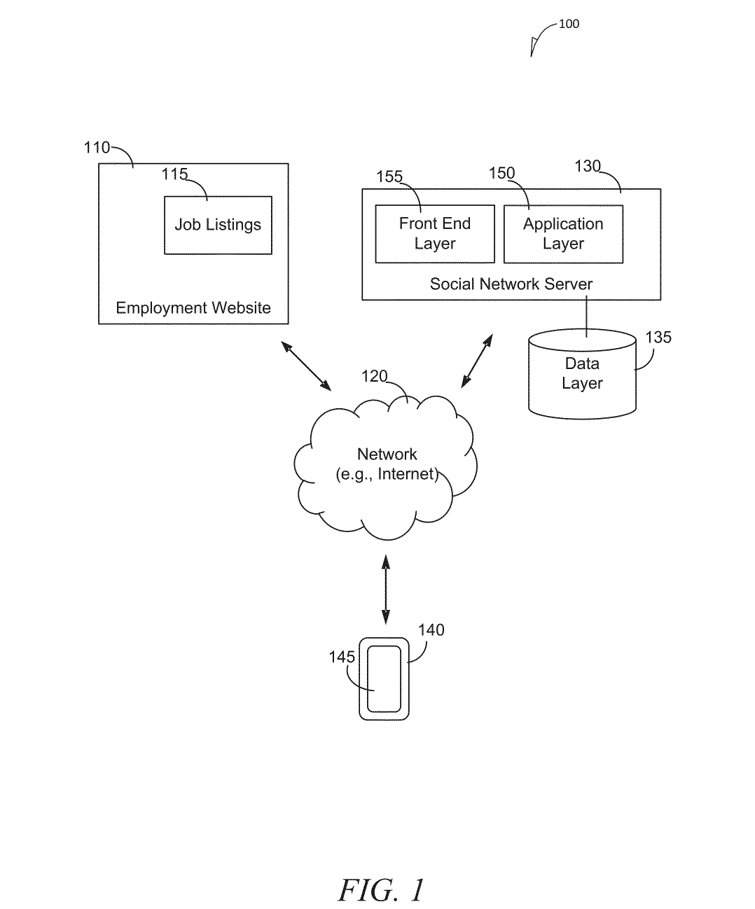

FIG. 1 is a block diagram illustrating an example of a network environment 100 including a server operating a system for providing job posting services to a user of a mobile computing device, consistent with some embodiments. The network environment 100 includes an employment website 110, such as a job aggregation website or employment page within a company website, that communicates via a network 120 with a social network server 130 and one or more mobile computing devices 140 associated with users, such as job posters with jobs listed and displayed by the employment website 110.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks. A mobile computing device 140 may be any suitable computing device, such as a smart phone, a tablet, a laptop, a gaming device, and/or any mobile device or computing device configured to display job listings 115 and receive selections from users of objects displayed by webpages and/or apps.

The social network server 130 may include an application layer 150 including applications that may provide functionality, such as obtaining job listing information from third-party websites (e.g., external to the social networking service, such as the employment website 110), posting job listings on the social networking service associated with the social network server, or facilitating receipt of payments from job posters via the mobile computing device 140. In some examples, the application layer 150 may provide functionality for executing an upgrade of an unpaid job posting by causing the social network server 130 (via a front end layer 155) to present a user interface object (e.g., a button or other user-selectable displayed object on a display of the mobile computing device 140) that, when selected by a job poster, causes the social network server 130 to obtain information associated with the job posting (e.g., job details) and present it to the user of the mobile computing device 140 via a display 145.

In some examples, the front end layer 155 may display components within the social network server 130 to selectively display job listing information, user interface objects, and so on, based on information associated with the social network server 130 that is stored in a data layer 135 (e.g., databases).

A social networking service is a useful location to post jobs so as to get views of the posted job from job candidates and/or other viewers of job listings on, for example, webpages of the social networking service. Often, a social networking service or other similar service, such as LinkedIn, Facebook, Google+, Twitter, and so on, stores various types of information associated with members of the site. For example, a friend-based social networking service may store interest information for a member (e.g., information about things a member “likes”), whereas a business-based social networking service may store accomplishment or experience information for a member (e.g., educational or work experience information). Additionally, the social network server 130 may store a variety of information associated with a member's social graph, such as information identifying other members within the member's social graph. This information regarding users of the social networking service may be used to target job postings to users that may be more likely to be a good fit for the job. This might be accomplished, for example, by comparing a job profile associated with a job posting to a user profile associated with a user. Therefore, an unpaid job posting might be viewed by users of the social networking service only via a job search interface, while a paid job posting might be directed to specifically targeted users of the social networking service via other communication channels of the social networking service.

Returning to FIG. 1, the mobile computing device 140 may display, via the display 145, one or more job listings to a user, as well as user interface objects proximate to the job listings, for selection by the user. For example, the user may navigate a browser or other app supported by the mobile computing device 140 to a webpage displayed by the social network server 130, and, in response to viewing representative details of a job associated with an unpaid job listing on the social networking service and advantages associated with a paid job posting, the user may elect (via a user interface object) to upgrade the unpaid job posting to a paid job posting.

Once the user interface object is selected, the mobile computing device 140 communicates with the application layer 150 of the social network server 130, which provides (via the front end layer 155) a user interface for facilitating payment of a fee associated with a paid job posting on the social networking service. The user interface for payments may display the terms and conditions of a paid job posting (including, for example, fee amount or posting duration) and may include fields for entering credit card information that identifies a credit card to be used for payment of the fee. The application layer 150 then confirms the validity of the credit card and the payment of the fee, after which the job is posted as a paid job posting by the social network server 130 and the user of the mobile computing device 140 receives a confirmation via the display 145 indicating that the unpaid job posting has been upgraded to a paid job posting that will be presented to targeted users of the social networking service.

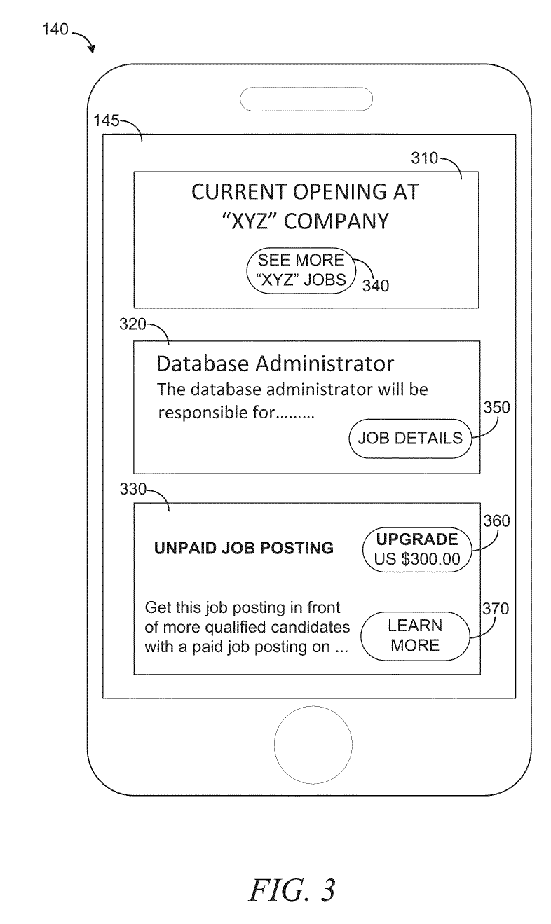

Thus, the systems and methods described herein may, in some examples, provide a user with a simple and effective process for posting jobs on a social networking service via a mobile computing device 140, among other benefits. FIGS. 3, 4, and 5 depict user interface objects and job posting information displayed to users of the mobile computing device 140, consistent with some embodiments.

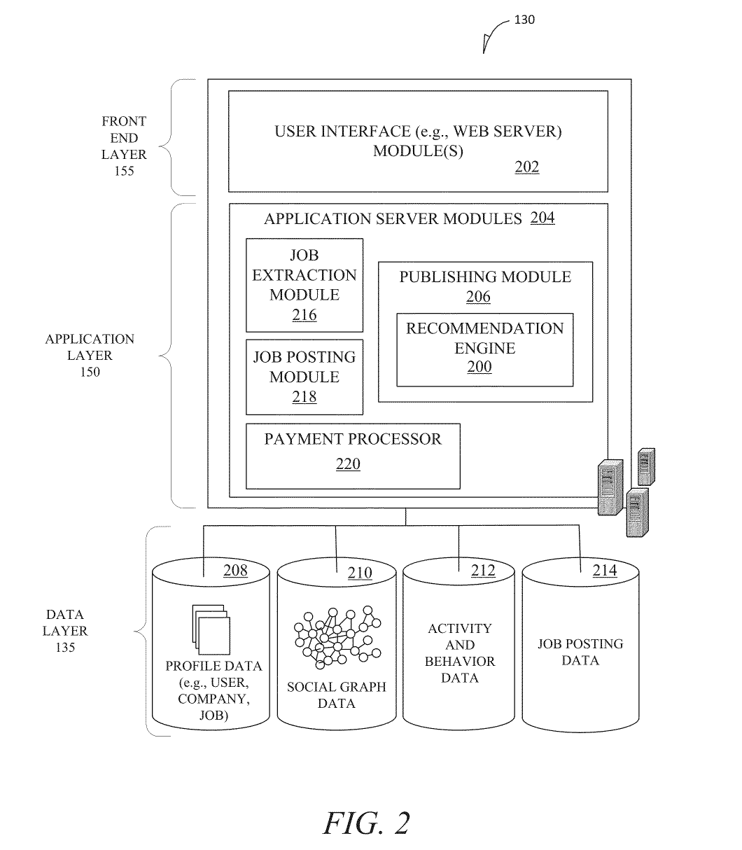

FIG. 2 is a block diagram illustrating various components of a social network server 130 with a job posting module 218 and a job extraction module 216 for extracting job listing information from external data sources, such as from job listings 115 on employment website 110. In an example, the social network server 130 is based on a three-tiered architecture, consisting of a front end layer 155, an application layer 150, and a data layer 135. As is understood by skilled artisans in the relevant computer and Internet-related arts, each module or engine shown in FIG. 2 may represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social network server 130 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end layer 155 of the social network server 130 consists of a user interface module(s) (e.g., a web server) 202, which receives requests from various client computing devices (such as the mobile computing device 140), and communicates appropriate responses to the requesting client devices. For example, the user interface module(s) 202 may receive requests in the form of Hypertext Transfer Protocol (HTTP) requests, or other web-based, application programming interface (API) requests. The application layer 150 includes various application server modules 204 (e.g., the job extraction module 216 and the job posting module 218), which, in conjunction with the user interface module(s) 202, generate various user interfaces (e.g., webpages) that may display (e.g., via the display 145) data retrieved from various data sources in the data layer 135. In some embodiments, individual application server modules 204 are used to implement the functionality associated with various services and features of the social network server 130. For instance, the ability to identify user profiles similar to (e.g., a good fit with) a job profile may be a service implemented in an independent application server module 204. Similarly, other applications or services that utilize a recommendation engine 200 to target specific users of the social networking service may be embodied in their own application server module(s) 204. Of course, one of ordinary skill in the art will realize that the application layer 150 may include other modules not shown in FIG. 2, such as modules that store and/or analyze information, modules that provide security or identification processes, and so on.

The data layer 135 may include several databases, including profile data 208, social graph data 210, activity and behavior data 212, and job posting data 214. The profile data 208 may store user profiles and job profiles, as well as profiles for additional social network “entities”, such as interest groups, companies, advertisements, events, news, discussions, tweets, questions and answers, and so forth. In some examples, the profile data 208 is processed in the background (e.g., offline) to generate pre-processed profile data (e.g., including calculated data points as well as raw data) that may be used by the recommendation engine 200, in real time, to make recommendations generally, and to identify user profiles similar to a job profile. In an example, the recommendation engine 200 may retrieve and process a user's social graph data 210 and a user's activity and behavior data 212 to identify user profiles similar to a job profile. Furthermore, one or more job postings and any associated metadata (e.g., date first posted, number of views, etc.) may be stored in the job posting data 214.

In various examples, when a person (e.g., a user) initially registers to become a user of the social networking service, the person may be prompted, by social network server 130, to provide some personal information, such as his or her name, age (such as by birth date), gender, interests, contact information, home town, address, educational background (such as schools, majors, etc.), employment history, skills, and professional organizations, the names of the user's spouse and/or family users, and so on. This information may be stored, for example, in the profile data 208.

Once registered, a user may invite other users, or be invited by other users, to connect via the social network server 130. A “connection” may involve a bilateral agreement by the users, such that both users acknowledge the establishment of the connection. Similarly, in some embodiments, a user may elect to “follow” another user. In contrast to establishing a “connection”, the concept of “following” another user typically is a unilateral operation, and in some examples, does not require acknowledgement or approval by the user that is being followed. This information may be stored, for example, in the social graph data 210 and additionally or alternatively in the activity and behavior data 212.

In an example embodiment, the social network server 130 may receive, via a user interface module(s) 202, a job profile generated by the job posting module 218 for each of a plurality of job postings to the social networking service. A job profile, used to generate a job posting (e.g., listing) typically is composed of profile data points including the name of the company or organization at which the job opening is available, the job title for the job opening, and a description of the job functions and the required or recommended skills, education, certifications and/or expertise. These job profiles may be submitted for paid or unpaid job postings on the social networking service. A paid job posting will be available with payment of a fee, for example, via the user interface module(s) 202 and a payment processor 220.

In an example, the social network server 130 may extract job profiles from job listings on various externally hosted third-party job listing websites. In some instances, an automated bot (e.g., the job extraction module 216) may automatically “crawl” and discover job listings 115 on employment website 110 for extraction, while in other instances, job listings may be obtained from a data feed maintained by one or more third-party partners. In any case, the social network server 130 will have a database (e.g., job posting data 214) containing both job postings that have been generated through the job posting module 218 (unpaid or for which a fee was paid) and external job postings (unpaid) obtained via extraction from a third-party website external to the social networking service (e.g., the employment website 110).

After the relevant job profile data points have been received or extracted, the job profile data points are used to populate respective job profiles which may be stored in the profile data 208. A job posting may then be generated, based on each said job profile, for presentation (e.g., via a publishing module 206) to users of the social networking service (e.g., user of the mobile computing device 140) with which the job posting module 218 is integrated. The extracted job profiles may only be used to generate unpaid job postings on the social networking service.

In an example embodiment, the publishing module 206 of the social network server 130 may then determine (e.g., via the job posting module 218) whether each generated job posting is for an unpaid job posting to the social networking service, and if so the job posting may be presented to users of the social networking service only via a standard “job search” user interface. In this way users of the social networking service that are actively searching for jobs (e.g., via a job search module in the application server modules 204) may be presented with the unpaid job posting, to the extent that it matches the user's search criteria. However, the unpaid job posting will not be published over other communication channels via the social networking service server's publishing module 206.

In an example embodiment, the publishing module 206 may then determine whether each job profile received via the job posting module 218 is for a paid job posting to the social networking service, and if so the job posting may be presented to users of the social networking service via the standard “job search” user interface so that users of the social networking service that are actively searching for jobs may be presented with the unpaid job posting. Furthermore, payment of a fee will entitle the job posting to be presented to users of the social networking service over other communication channels of the social networking service via the publishing module 206. For example, a paid job posting may be presented to a user via a direct e-mail to the user or via placement of the posting on the user's social networking service “homepage”, if it is determined that the job posting may be attractive to the user based on a comparison (e.g., by the recommendation engine 200) of the user's profile and the job profile associated with the job posting.

In an example, the recommendation engine 200 may operate to compare profiles and make recommendations (e.g., to the publishing module 206) based on the comparisons. The data representing each individual instance of a particular social network entity, such as a user profile or a job profile from the profile data 208, is processed by the recommendation engine 200 to access the relevant profiles on which a similarity (e.g., compatibility) analysis is to be performed. In various examples, in the case of a user profile, only certain sections or portions of a user's profile may be selected for use in determining the similarity of any two profiles, such as the user profile and a job profile. As such, the recommendation engine 200 may process each user profile to access the relevant profile data points from each user profile, for example, work skills or work experience. In addition to simply accessing certain profile data points from relevant entity profiles, the recommendation engine 200 may derive certain profile data points based on other information included in the data layer 135, such as a user's activity and behavior data 212 and social graph data 210.

In some examples, the recommendation engine 200 may standardize and/or normalize various profile data points, such as a user's job or position title, or the name of a company at which a user has indicated being employed. In some examples, certain profile data points may be retrieved from external data sources, by using other information included in the user's profile as part of a query to the external data sources.

Once the relevant profiles have been accessed, computed, derived, or retrieved, relevant profiles of the one or more selected users or jobs may be stored as pre-processed profiles (in the profile data 208) for the recommendation engine 200. For instance, in the case of user profiles, the process may result in enhanced user profiles that include only the relevant profile data points accessed from a user's profiles as well as any derived or retrieved profile data points. The enhanced profiles may be used by the recommendation engine 200 when the recommendation engine 200 compares the relevant profile data points from the job profile against each user profile's set of corresponding profile data points to identify those user profiles with the highest compatibility scores with respect to the job profile.

In example embodiments, the job posting module 218 may generate a user interface (e.g., via the user interface module(s) 202) wherein a user (e.g., via the display 145) is provided with options (e.g., buttons or entry fields) for performing at least one of the following: viewing details regarding a job posting on the social networking service, requesting further details regarding a job posting on the social networking service, requesting details regarding job postings on the social networking service that are associated with a specific company, viewing details regarding advantages of a paid job posting on the social networking service (in comparison to an unpaid posting), requesting further details regarding advantages of a paid job posting, viewing fee and terms/conditions for upgrading an unpaid job posting to a paid job posting, or processing payment of the fee associated with upgrading an unpaid job posting to a paid job posting. The user interface objects may present data obtained from the data layer 135 (e.g., the profile data 208), and the functionality of user interface objects may be provided by application modules in the application layer 150 (e.g., the job posting module 218 or the payment processor 220).

In an example embodiment, the publishing module 206 may publish a paid job posting to users of the social network server 130 via channels of the social networking service besides a standard “job search” user interface. The other communication channels of the social network server 130 may include website placement (e.g., placement in a corner of a targeted user's social social networking service network homepage), website email direct to a targeted user (e.g. targeted via the recommendation engine 200), website messaging to a targeted user, or links associated with other job postings. The links associated with other job postings on the social networking service comprise links to other jobs associated with paid job postings, for example, a link to a job at a company associated with a job posting, a link to receive notices regarding jobs at a company associated with a job posting, a link to other jobs that are similar to a job associated with a job posting, or a link to share a job posting with another user of the social networking service.

### Posting a Job Via a Mobile Computing Device

As described herein, in some example embodiments, the social network server 130 includes and supports an application layer 150, such as a system that enables and/or facilitates the posting of jobs to a social networking service via custom user interfaces for a mobile computing device (e.g., the mobile computing device 140).

As illustrated in FIG. 2, the application layer 150 includes a variety of functional modules. One skilled in the art will appreciate that the functional modules are implemented with a combination of software (e.g., executable instructions, or computer code) and hardware (e.g., at least a memory and a processor). Accordingly, as used herein, in some embodiments, a module is a processor-implemented module and represents a computing device having a processor that is at least temporarily configured and/or programmed by executable instructions stored in memory to perform one or more of the particular functions that are described herein.

Referring to FIG. 2, the application layer 150 includes a job extraction module 216, a job posting module 218, a publishing module 206 (including a recommendation engine 200), a payment processor 220, and other modules not shown in FIG. 2. The job extraction module 216 and the job posting module 218 may provide job postings for publication by the social network server 130, for example, via the publishing module 206.

In some examples, the job extraction module 216 may extract a job profile from a job posting on an external website (e.g., the employment website 110) and a job posting (referred to herein as an external job posting) based on the extracted job profile may be published by the social network server 130 (via the publishing module 206) across the social networking service, for example, via a “job search” user interface provided by the user interface module(s) 202. The extracted job profile may include contact information (e.g., e-mail) for responding to the job posting, or company information (e.g., company name and location) regarding the company for which the job was posted on the external website. This information may be used to contact an individual (e.g., a user of the mobile computing device 140) who may be responsible for the job posting on the external website or for job postings at the company associated with the job posting. An e-mail (or other electronic communication) may then be directed (e.g., via the publishing module 206) to a mobile computing device of the responsible individual informing them that their job posting is now being hosted free of charge on the social networking service associated with the social network server 130.

FIG. 3 is a display diagram illustrating job posting user interface options provided to a user of a mobile computing device. As shown in FIG. 3, a mobile computing device 140 including a display 145 and at least one processor may receive a communication from the social network server 130 including information associated with an unpaid job posting on the social networking service, for example, an external job posting based on an extracted job profile. The mobile computing device 140 may then present to a user of the mobile computing device 140, via user interface objects that may be generated by the user interface module(s) 202 (e.g., user interface objects 310 and 320 on the display 145), at least one detail of the job associated with the unpaid job posting. In this example the job is for a “Database Administrator” position at “XYZ” company. The details of the job may be presented together with a “Job Details” user interface object 350 for requesting more details of the job associated with the unpaid job posting. Based on a user selection of the “Job Details” user interface object 350, the social network server 130 may provide further details of the job to the mobile computing device 140, for example, more information from the extracted job profile (in the profile data 208) associated with the unpaid job posting. This information (further details of the job associated with the unpaid job posting) may be presented to the user via the user interface object 320 on the display 145.

The mobile computing device 140 may also present to the user of the mobile computing device 140 (via the user interface object 310 on the display 145) a “Company” user interface object 340 for requesting details regarding other job postings on the social networking service that are associated with the company (“XYZ”) for which the presently displayed job is posted on the social networking service. Based on a user selection of the “Company” user interface object 340, the social network server 130 may provide details associated with other job postings by company “XYZ” on the social networking service to the mobile computing device 140, for example, information from the job posting data 214.

The mobile computing device 140 may also present to the user of the mobile computing device 140 (via a user interface object 330 on the display 145) at least one advantage of a paid job posting on the social networking service as compared to an unpaid job posting on the social networking service. For example, it may be noted that unpaid job postings are only presented to active job seekers on the social networking service via a “job search” user interface, while paid job postings are targeted to specific users of the social networking service that have been determined to be a good match for the job (e.g., by the recommendation engine 200) via other communication channels of the social network server 130. The advantages of the paid job posting may be presented via the user interface object 330 together with a “Learn More” user interface object 370 for requesting that more advantages associated with a paid job posting on the social networking service be displayed. Based on a user selection of the “Learn More” user interface object 370, the social network server 130 may provide further advantages/benefits of the paid job posting to the mobile computing device 140, for example, information from the job posting data 214. The advantages may, for example, include: improved visibility in job search, automated job recommendations, suggested professionals, actionable job analysis, applicant management tools, and employment branding features.

In some examples, the advantages of the paid job posting may be presented via the user interface object 330 together with an “Upgrade” user interface object 360 for requesting an upgrade of the unpaid job posting to a paid job posting on the social networking service. The “Upgrade” user interface object 360 may display the fee amount to be paid for the upgrade to a paid job posting, for example US $300.00. In some examples, this fee amount may be based on the geographical location of the mobile computing device 140. For example, if geolocation capabilities (or other methods) of the mobile computing device 140 determine that the mobile computing device 140 is located in England then the fee amount for the upgrade may be presented as £ 185 GBP in the “Upgrade” user interface object 360. Based on a user selection of the “Upgrade” user interface object 360, the social network server 130 may provide information regarding payment of the fee associated with the upgrade and any terms and conditions associated with the upgrade to the mobile computing device 140, for example, information from the payment processor 220.

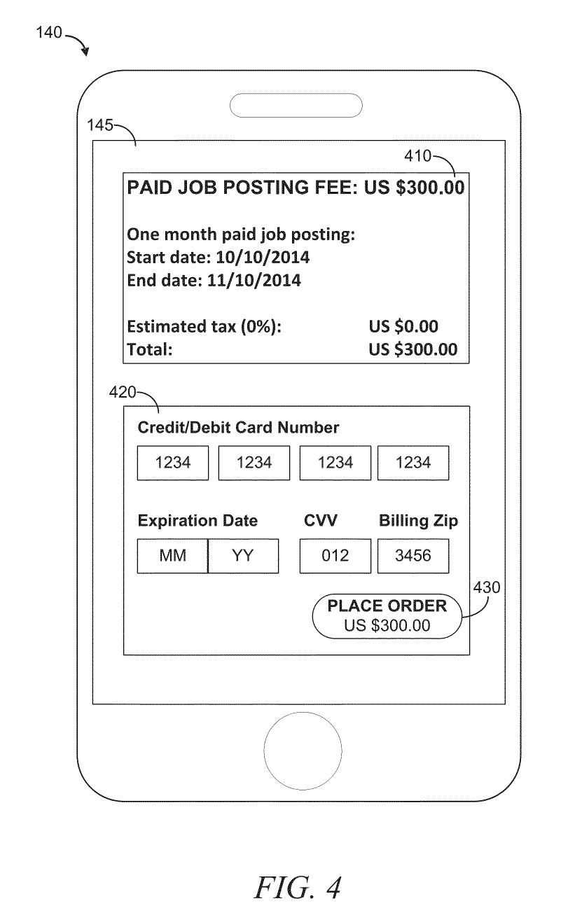

FIG. 4 is a display diagram illustrating job posting user interface options provided to a user of a mobile computing device. As shown in FIG. 4, the information regarding payment of the fee associated with the upgrade may be presented to the user of the mobile computing device 140, via user interface objects that may be generated by the user interface module(s) 202 (e.g., user interface objects 410 and 420) on the display 145. The terms and conditions presented in the user interface object 410 may, for example, include the dates during which the job will be listed as a paid job posting (e.g., Oct. 10, 2014 to Nov. 10, 2014) on the social networking service, as well as any fees (e.g., US $300.00) and taxes (e.g., US $0.00) associated with a paid job posting on the social networking service.

In some examples, the information regarding payment of the fee associated with the upgrade may include a user interface object 420 for accepting credit card information from the user of the mobile computing device 140. The user interface object 420 may include fields for receiving relevant credit card information from the user, for example, the credit card number, the expiration date, the security code (CVV), and the billing zip code. The user interface object 420 may also include fields for receiving information associated with other forms of electronic payment, for example, information related to a third-party electronic payment processing application.

Furthermore, in some examples, the user interface object 420 may be presented together with a “Place Order” user interface object 430 for making payment of the fee associated with an upgrade of the unpaid job posting to a paid job posting on the social networking service. The “Place Order” user interface object 430 may display the fee amount to be paid for the upgrade to a paid job posting, for example US $300.00. As explained above, this fee amount may be based on the geographical location of the mobile computing device 140. Based on a user selection of the “Place Order” user interface object 430, the social network server 130 may, via the payment processor 220, process the credit card transaction (or other electronic payment transaction) with information entered by the user via the user interface object 420. Based on the payment processor 220 confirming validity of the credit card and confirming the credit card transaction, the publishing module 206 of the social network server 130 may publish the job posting as a paid job posting across the relevant communications channels of the social networking service, for example, as determined by the recommendation engine 200.

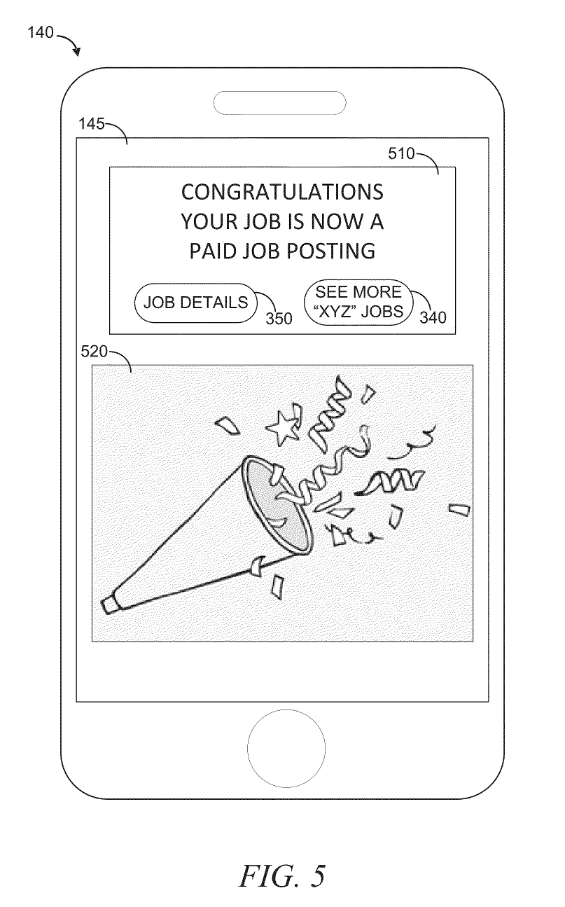

FIG. 5 is a display diagram illustrating job posting user interface options provided to a user of a mobile computing device. As shown in FIG. 5, based on the payment processor 220 confirming validity of the credit card and confirming the credit card transaction, the publishing module 206 of the social network server 130 may generate a user interface object 510 on the display 145 for presenting the user of the mobile computing device 140 with confirmation that payment has been received and that the unpaid job posting has been upgraded to a paid job posting. In some examples, the user interface object 510 may also include the “Job Details” user interface object 350 and the “Company” user interface object 340 so that the user may review the details of the new paid job posting or view other jobs associated with the company (“XYZ”) for which the user of the mobile computing device 140 has upgraded a job posting.

In some examples, the publishing module 206 of the social network server 130 may also generate a user interface object 520 for emphasizing that the transaction has been successfully completed and the unpaid job posting has been upgraded to a paid job posting. In the example of FIG. 5, a celebratory image (horn blowing) is displayed in the user interface object 520 to emphasize that successful transaction.

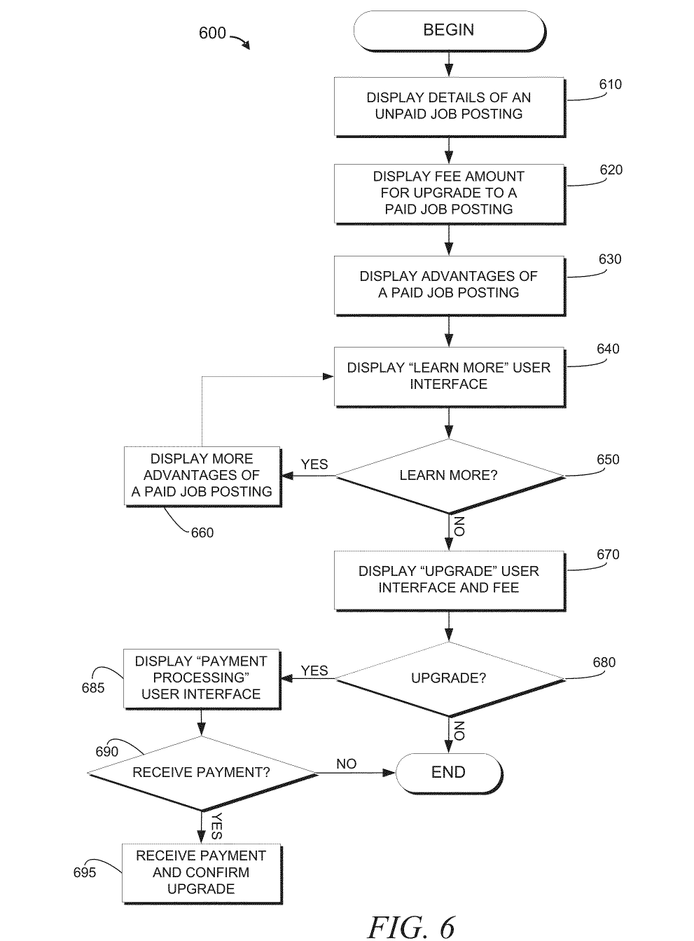

FIG. 6 is a flow diagram illustrating an example method 600 performed by a server associated with a social networking service to provide information and functionality associated with job postings via a mobile computing device.

In step 610, the mobile computing device 140 may present to a user of the mobile computing device 140, via user interface objects on the display 145, at least one detail of a job associated with an unpaid job posting on a social networking service.

In step 620, the user may be presented with the fee amount to be paid for upgrading the unpaid job posting to a paid job posting. In some examples, this fee amount may be based on the geographical location of the mobile computing device 140 as determined, for example, via geo-location.

In step 630, the mobile computing device 140 may also present to the user at least one advantage of a paid job posting on the social networking service as compared to an unpaid job posting on the social networking service. For example, it may be noted that unpaid job postings are only presented to active job seekers on the social networking service via a “job search” user interface, while paid job postings are also published across other communication channels of the social networking service.

In step 640, the advantages of the paid job posting may be presented together with a “Learn More” user interface object for requesting that more advantages associated with a paid job posting on the social networking service be displayed.

In step 650, based on a user selection of the “Learn More” user interface object, the user may be presented, in step 660, with further advantages/benefits of the paid job posting (e.g., via the display 145). The user may then continue to request further advantages by selection of the “Learn More” user interface object (e.g., in step 650) until no further advantages remain that have not already been listed, at which point the “Learn More” user interface object may be “greyed out” or otherwise visually indicate that it is no longer usable.

In step 670, the advantages of the paid job posting may be presented to the user together with an “Upgrade” user interface object for requesting an upgrade of the unpaid job posting to a paid job posting on the social networking service. The “Upgrade” user interface object may display the fee amount for upgrading an unpaid job posting to a paid job posting on the social networking service.

In step 680, based on a user selection of the “Upgrade” user interface object, the user may be presented, in step 685, with a payment processing user interface for payment of the fee amount associated with the upgrade and any terms and conditions associated with the upgrade. The payment processing user interface may include a “Place Order” user interface object for submitting the order (e.g., authorizing payment) for the upgrade of the unpaid job posting to a paid job posting on the social networking service. If the user does not elect to upgrade the job posting, the method may end.

In step 690, based on a user selection of the “Place Order” user interface object (which may include, for example, entering credit card information) and subsequent receipt of payment of the fee, the user may be presented, in step 695, with a confirmation message indicating a successful completion of the transaction and a paid posting of the job on the social networking service. If the user does not elect to place the order to upgrade the job posting, the method may end.

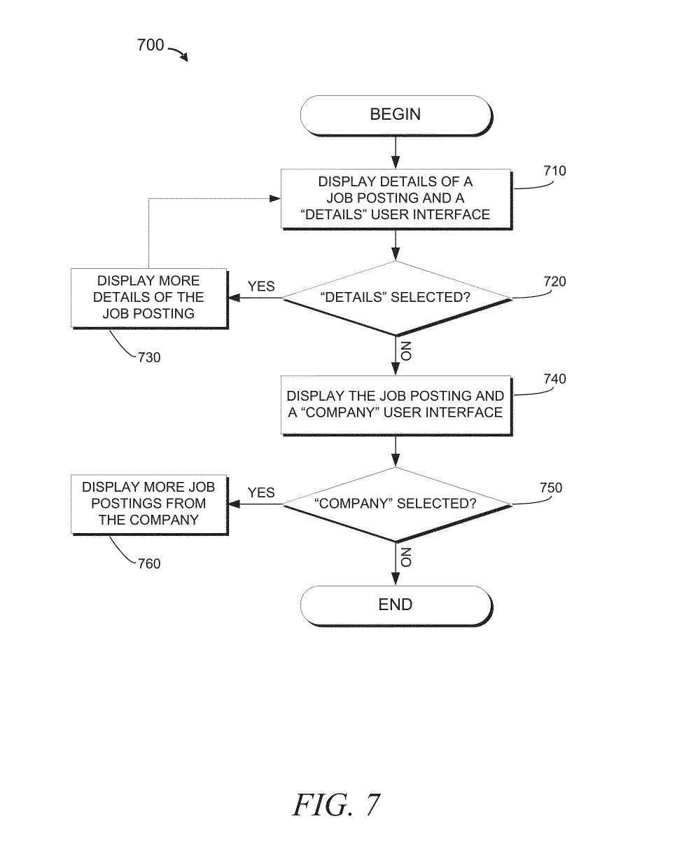

FIG. 7 is a flow diagram illustrating an example method 700 for displaying information associated with job postings via a mobile computing device, consistent with some embodiments.

In step 710, details of a job may be presented together with a “Job Details” user interface object for requesting more details of the job associated with an unpaid job posting on a social networking service.

In step 720, based on a user selection of the “Job Details” user interface object, the user may be presented, in step 730, with further details of the job. This information (further details of the job associated with the unpaid job posting) may be presented to the user via a user interface object on the display 145.

In step 740, the user of the mobile computing device 140 may be presented with a “Company” user interface object 340 for requesting details regarding other job postings on the social networking service that are associated with the company for which the presently displayed job is posted on the social networking service.

In step 750, based on a user selection of the “Company” user interface object 340, the user may be presented, in step 760, with details associated with other job postings by company “XYZ” on the social networking service.

### CONCLUSION

Some example embodiments of the technology, therefore, enable an employment site to receive application submissions on behalf of job candidates based on information obtained from social networking services that include the job candidates as members, among other things.

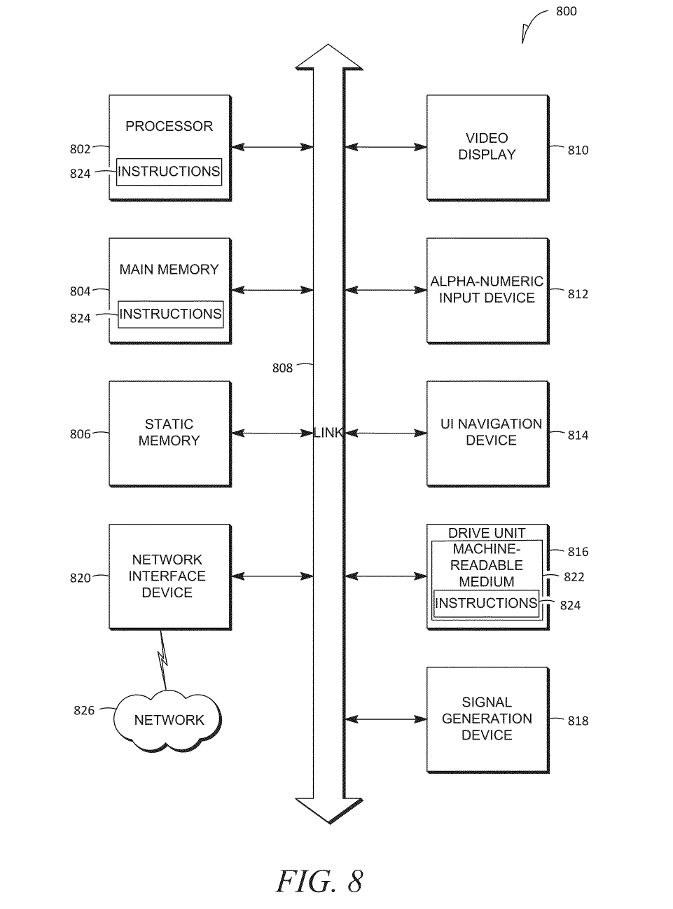

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system within which instructions 824 (e.g., software) for causing the machine 800 to perform any one or more of the methodologies discussed herein may be executed. In alternative examples, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a video display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a user interface (UI) navigation device 814 (e.g., a mouse, a touchpad, a trackball, a joystick, a motion sensor, or another pointing instrument), a drive unit 816, a signal generation device 818 (e.g., a speaker), and a network interface device 820.

The drive unit 816 includes a machine-readable medium 822 on which are stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered machine-readable media. The instructions 824 may be transmitted or received over a network 826 via the network interface device 820.

As used herein, the term “memory” refers to a machine-readable medium able to store data temporarily or permanently, and may be taken to include, but not be limited to, random-access memory (RAM), read-only memory (ROM), buffer memory, flash memory, and cache memory. While the machine-readable medium 822 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions 824 (e.g., software) for execution by a machine (e.g., the machine 800), such that the instructions, when executed by one or more processors of the machine (e.g., the processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

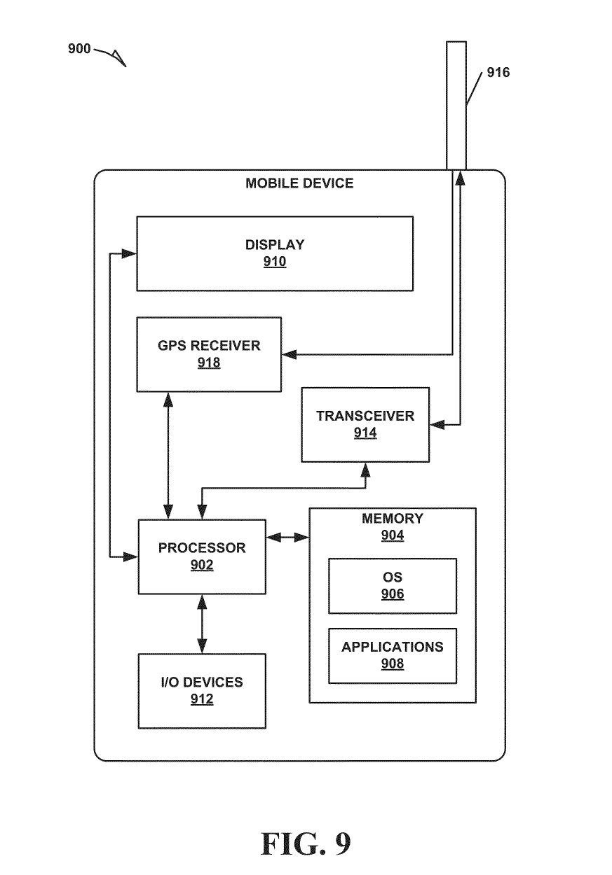

FIG. 9 is a block diagram illustrating a mobile device 900, according to an example embodiment. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or another type of memory, is typically accessible to the processor 902. The memory 904 may be adapted to store an operating system (OS) 906, as well as applications 908, such as a mobile location enabled application that may provide location-based services (LBSs) to a user. The processor 902 may be coupled, either directly or via appropriate interphotory hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
presenting, by a display of a mobile computing device, at least one detail of a job that is posted on a social networking service as an unpaid job posting together with an “upgrade” user interface object for upgrading the unpaid job posting to a paid job posting on the social networking service with associated advantages in comparison to the unpaid job posting;
presenting, by the display, a fee for upgrading the unpaid job posting and at least one of the associated advantages of the paid job posting together with a “learn more” user interface object for requesting that other associated advantages of the paid job posting be presented;
based on receiving a selection of the “learn more” user interface object, presenting, by the display, a specified number of others of the associated advantages of the paid job posting; and
based on receiving a selection of the “upgrade” user interface object, presenting, by the display, a user interface for processing payment of the fee.

2. The method of claim 1, further comprising:
presenting, by the display, a “job details” user interface object for requesting that other details of the job be presented; and
based on receiving a selection of the “job details” user interface object, presenting, by the display, a specified number of the other details of the job.

3. The method of claim 1, further comprising:
presenting, by the display, a “company” user interface object for requesting that details of other jobs at a company associated with the unpaid job posting on the social networking service be presented; and
based on receiving a selection of the “company” user interface object, presenting, by the display, details of at least one other job at the company associated with the unpaid job posting on the social networking service.

4. The method of claim 1, wherein the fee presented by the display of the mobile computing device is based on a geographical location of the mobile computing device.

5. The method of claim 1, wherein the user interface for processing the payment of the fee includes terms and conditions of the paid job posting on the social networking service.

6. The method of claim 1, wherein the user interface for processing the payment of the fee includes a field for receiving credit card information and a “place order” user interface object for submitting the payment of the fee using a credit card associated with the credit card information.

7. The method of claim 6, further comprising:
based on receiving a selection of the “place order” user interface object and confirming the credit card information, posting the job as the paid job posting on the social networking service and presenting, by the display, a notice confirming that the unpaid job posting has been upgraded to the paid job posting.

8. A system comprising:
a mobile computing device including a display and at least one processor, the mobile computing device configured to:
display at least one detail of a job that is posted on a social networking service as an unpaid job posting together with an “upgrade” user interface object for upgrading the unpaid job posting to a paid job posting on the social networking service with associated advantages in comparison to the unpaid job posting;
display a fee for upgrading the unpaid job posting and at least one of the associated advantages of the paid job posting together with a “learn more” user interface object for requesting that others of the associated advantages of the paid job posting be displayed;
based on receiving a selection of the “learn more” user interface object, display a specified number of other associated advantages of the paid job posting; and
based on receiving a selection of the “upgrade” user interface object, display a user interface for processing payment of a fee.

9. The system of claim 8, wherein the mobile computing device is further configured to:
display a “job details” user interface object for requesting that other details of the job be displayed; and
based on receiving a selection of the “job details” user interface object, display a specified number of the other details of the job.

10. The system of claim 8, wherein the mobile computing device is further configured to:
display a “company” user interface object for requesting that details of other jobs at a company associated with the unpaid job posting on the social networking service be displayed; and
based on receiving a selection of the “company” user interface object, display details of at least one other job at the company associated with the unpaid job posting on the social networking service.

11. The system of claim 8, wherein the fee displayed by the mobile computing device is based on a geographical location of the mobile computing device.

12. The system of claim 8, wherein the user interface for processing the payment of the fee includes terms and conditions of the paid job posting on the social networking service.

13. The system of claim 8, wherein the user interface for processing the payment of the fee includes a field for receiving credit card information and a “place order” user interface object for submitting the payment of the fee using a credit card associated with the credit card information.

14. The system of claim 13, wherein the mobile computing device is further configured to:
based on receiving a selection of the “place order” user interface object and confirming the credit card information, post the job as the paid job posting on the social networking service and display a notice confirming that the unpaid job posting has been upgraded to the paid job posting.

15. A memory device communicatively coupled to a mobile computing device including at least one processor and a display, the memory device comprising instructions which, when performed by the at least one processor, cause the mobile computing device to:
display at least one detail of a job that is posted on a social networking service as an unpaid job posting together with an “upgrade” user interface object for upgrading the unpaid job posting to a paid job posting on the social networking service with associated advantages in comparison to the unpaid job posting;
display a fee for upgrading the unpaid job posting and at least one of the associated advantages of the paid job posting together with a “learn more” user interface object for requesting that others of the associated advantages of the paid job posting be displayed;
based on receiving a selection of the “learn more” user interface object, display a specified number of other associated advantages of the paid job posting; and
based on receiving a selection of the “upgrade” user interface object, display a user interface for processing payment of a fee.

16. The memory device of claim 15, wherein the memory device further comprises instructions that cause the mobile computing device to:
display a “job details” user interface object for requesting that other details of the job be displayed; and
based on receiving a selection of the “job details” user interface object, display a specified number of the other details of the job.

17. The memory device of claim 15, wherein the memory device further comprises instructions that cause the mobile computing device to:
display a “company” user interface object for requesting that details of other jobs at a company associated with the unpaid job posting on the social networking service be displayed; and
based on receiving a selection of the “company” user interface object, display details of at least one other job at the company associated with the unpaid job posting on the social networking service.

18. The memory device of claim 15, wherein the user interface for processing the payment of the fee includes terms and conditions of the paid job posting on the social networking service.

19. The memory device of claim 15, wherein the user interface for processing the payment of the fee includes a field for receiving credit card information and a “place order” user interface object for submitting the payment of the fee using a credit card associated with the credit card information.

20. The memory device of claim 19, wherein the memory device further comprises instructions that cause the mobile computing device to:
based on receiving a selection of the “place order” user interface object and confirming the credit card information, post the job as the paid job posting on the social networking service and display a notice confirming that the unpaid job posting has been upgraded to the paid job posting.
